(19) United States
(12) Patent Application Publication
(10) Pub. No.: US 2003/0075688 A1
(43) Pub. Date: Apr. 24, 2003

(54) Radiation image storage panel

(75) Inventor: Shinichiro Fukui, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/231,257

(22) Filed: Aug. 30, 2002

(30) Foreign Application Priority Data
Aug. 30, 2001 (JP) 2001-261911

(51) Int. Cl. G03B 42/08

(52) U.S. Cl. 250/484.4

(57) ABSTRACT

A radiation image storage panel having an air-tightly closed space formed of two rigid sheets and a frame placed between the sheets and a phosphor layer placed in the closed space, in which the frame has four corners in the form of concave arc or concave polygon of obtuse angles keeps its air-tight sealing structure for a long period of time and is resistant to deterioration of the phosphor layer.

### FIELD OF THE INVENTION

The invention relates to a radiation image storage panel favorably employable in a radiation image recording and reproducing method utilizing stimulated emission of a stimulable phosphor.

### BACKGROUND OF THE INVENTION

When the stimulable phosphor is exposed to radiation such as X-rays, it absorbs and stores a portion of the radiation energy. The stimulable phosphor then emits stimulated emission according to the level of the stored energy when the phosphor is exposed to electromagnetic wave such as visible light or infrared rays (i.e., stimulating light).

A radiation image recording and reproducing method utilizing the stimulable phosphor has been widely employed in practice. The method employs a radiation image storage panel comprising the stimulable phosphor, and comprises the steps of causing the stimulable phosphor of the storage panel to absorb radiation energy having passed through an object or having radiated from an object; sequentially exciting the stimulable phosphor with a stimulating light to emit stimulated light; and photo-electrically detecting the emitted light to obtain electric signals giving a visible radiation image. The storage panel thus treated is subjected to a step for erasing radiation energy remaining therein, and then stored for the use in the next recording and reproducing procedure. Thus, the radiation image storage panel can be repeatedly used.

The radiation image storage panel (often referred to as stimulable phosphor sheet) has a basic structure comprising a substrate and a stimulable phosphor layer provided thereon.

The phosphor layer is generally formed by coating a dispersion of phosphor particles in a binder solution on the substrate and drying the coated dispersion on the substrate, and therefore comprises a binder and phosphor particles dispersed therein.

It is desired that radiation image storage panels used in these methods have sensitivity as high as possible and further can give a reproduced radiation image of high quality (in regard of sharpness and graininess).

It is known that a radiation image storage panel having on a substrate a stimulable phosphor film prepared by vapor deposition (or vapor-accumulating method) such as vacuum vapor deposition or sputtering gives a reproduced radiation image with high sensitivity as well as high sharpness.

Japanese Patent Provisional Publication No. 62-47600 discloses a method in which a stimulable phosphor film of a radiation image storage panel is formed by electron beam evaporation (which is a kind of vapor deposition method). In the method, an electron beam generated by an electron gun is applied onto a stimulable phosphor or its starting materials (i.e., evaporation source) to heat and vaporize the source, to deposit the vapor to form a phosphor film on the surface of the substrate. Thus formed phosphor film consists essentially of prismatic crystals of the stimulable phosphor. In the phosphor film, there are cracks between the prismatic crystals of the stimulable phosphor. For this reason, the stimulating rays are efficiently applied to the phosphor and the stimulated emission are also efficiently taken out. Hence, a radiation image of high sharpness can be obtained with high sensitivity.

Japanese Patent Publication No. 6-77079 describes a radiation image storage panel in which a stimulable phosphor film is formed by vapor deposition to have a fine block structure.

It is known that the phosphor layer, particularly the phosphor layer formed by vapor deposition easily deteriorates to lower its performance when it is kept in contact with water or water vapor.

Accordingly, it has been proposed in Japanese Patents No. 2,829,610 and No. 3,046,646 to enclose the phosphor layer, particularly the phosphor layer formed by vapor deposition, with an air-tightly closed space which is formed of two rigid sheets and a frame placed between the sheets. The frame has four corners at 90° (i.e., right angle).

### SUMMARY OF THE INVENTION

According to the study of the present inventors, it has been now discovered that the closed space of the radiation image storage panel which is formed of two rigid sheets and a frame having four right angular does not sufficiently keep the enclosed phosphor layer from ambient wet atmosphere when the storage panel is stored in atmospheric conditions for a long period of time or repeatedly employed. In more detail, when the storage panel is stored in atmospheric conditions for a long period of time or repeatedly employed, the frame is apt to deform or cracks are produced in the frame, particularly, at the areas of right angular corners.

The present inventors have assumed that the deformation of frame and production of cracks in the frame occur because the width of the frame at the areas of right angular corners is large in comparison with areas between the adjoining corners, and confirmed that the deformation of frame and production of cracks in the frame are obviated, and deterioration of the phosphor layer of the radiation image storage panel is obviated by so producing the frame as to have four corners in the form of concave arc or concave polygon of obtuse angles.

The present invention resides in a radiation image storage panel having an air-tightly closed space formed of two rigid sheets and a frame placed between the sheets and a phosphor layer placed in the closed space, wherein the frame has four corners in the form of concave arc or concave polygon of obtuse angles (i.e., angles of greater than 90°).

The radiation image storage panel of the invention claim 1, wherein all corners are in the form of concave arc having a radius in the range of 0.5 to 200 mm or all corners are formed of concave polygons each of whose corners has an angle of greater than 135°.

Further, the frame of the radiation image storage panel of the invention preferably has thicknesses varying within 30% based on an average of the thicknesses.

### BRIEF DESCRIPTION OF DRAWINGS

FIG. 1 is a vertical sectional view of an example of the radiation image storage panel of the invention.

FIG. 2 is a plan view of the frame 16 of the radiation image storage panel illustrated in FIG. 1.

FIG. 3 is a plan view of a frame of different form of the radiation image storage panel of the invention.

FIG. 4 is a plan view of a frame of different form of the radiation image storage panel of the invention.

FIG. 5 is a vertical sectional view of another example of the radiation image storage panel of the invention.

FIG. 7 is a vertical sectional view of a different example of the radiation image storage panel of the invention.

### DETAILED DESCRIPTION OF THE INVENTION

The constitution of the radiation image storage panel of the invention is further described by referring to the attached drawings.

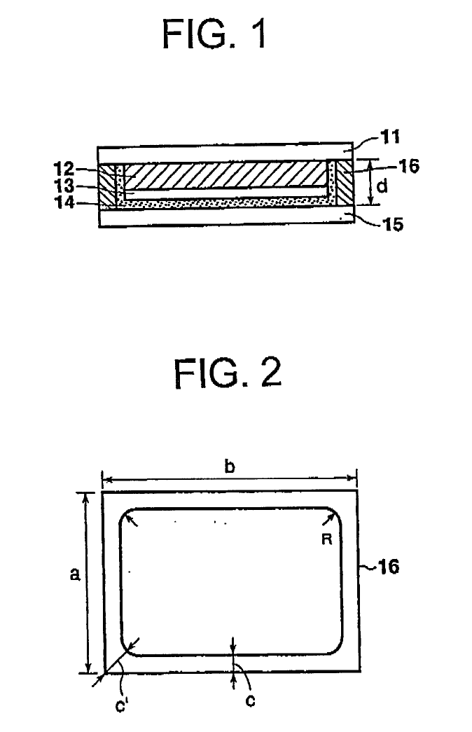

FIG. 1 illustrates a vertical sectional view of an example of the radiation image storage panel of the invention. In FIG. 1, the radiation image storage panel is composed of a first rigid sheet 11, a phosphor layer 12, a light-reflecting layer 13, a filling layer 14, a second rigid sheet 15, and a frame (i.e., spacer frame) 16. The frame is produced in one unit having no joints. On and under the frame 16 are fixed the first rigid sheet 11 and the second rigid sheet 15 using adhesive. Thus, the phosphor layer 12 is sealed in the closed space formed of the two rigid sheets 11, 15 and the frame 16, so that the phosphor layer 12 is kept from atmospheric surroundings. In the radiation image storage panel of FIG. 1, the phosphor layer 12 is placed on the first rigid sheet 11. In this case, the radiation image stored in the phosphor layer 12 is read from the side of the first rigid sheet 11.

The light-reflecting layer 13 and filling layer 14 can be omitted.

In FIG. 2, the plan form of the frame 16 of FIG. 1 is illustrated. The frame 16 of FIG. 2 has four corners in the form of concave arc. All corners are in the form of concave arc having a radius (R) in the range of 0.5 to 200 mm. The width of the frame 16 is almost equal in the corner areas and the areas between the corners. The width of the frame 16 generally is in the range of 2 to 50 mm, and a ratio between the width at the non-corner area (c) and the width at the corner area (c′) preferably is in the range of 1:1.4 to 1:6. The frame is nearly rectangular and generally has sizes of 425-550 mm (for a) and 440-550 mm (for b). It is preferred to produce a space of 420 mm×430 within the frame 16 to ensure the storage of a radiation image in the phosphor layer within the frame 16.

The frame 16 generally has an average thickness (d) in the range of 0.5 to 20 mm. The frame 16 preferably has an equal thickness in the whole area, within a deviation of 30%, more preferably within a deviation of 10%, most preferably within a deviation of 5%.

The frame 16 is preferably made of material showing low permeation of air as well as low permeation of gaseous water, such as glass material, ceramics, metal, or plastics. Specifically preferred are inorganic or organic glass material such as silicate glass. The frame is preferably prepared utilizing a water-jet process.

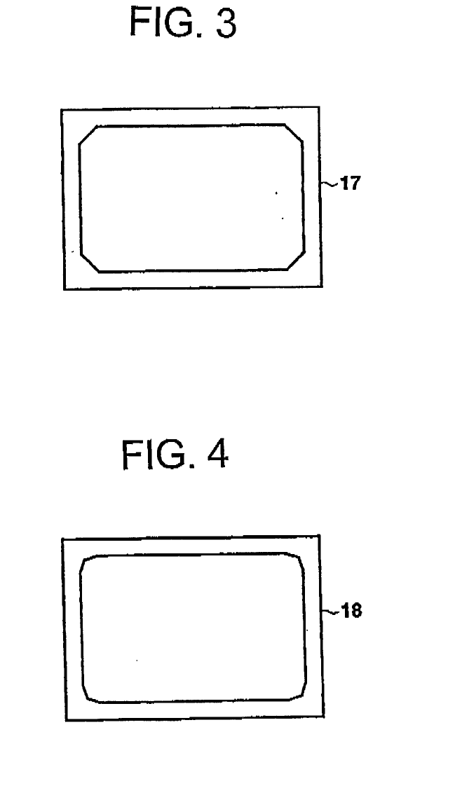

The frames of other forms are illustrated in FIG. 3 and FIG. 4. Each of the frames 17, 18 has a united structure and has four corners in the form of concave polygon of obtuse angles (i.e., angles of greater than 90°). The frame 17 in FIG. 3 has four corners in the form of concave polygon of 135°. The frame 18 in FIG. 4 has four corners in the form of concave polygon of 150°. The straight line of the polygonal corner preferably has a length of 0.1 to 100 mm.

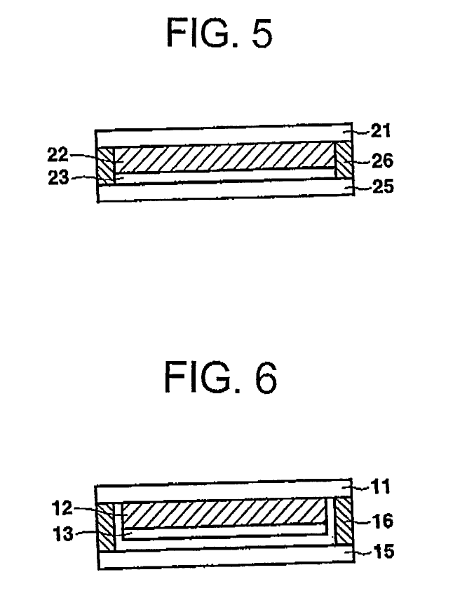

FIG. 5 illustrates a vertical sectional view of another e le of the radiation image storage panel of the invention. In FIG. 5, the radiation image storage panel is composed of a first rigid sheet 21, a phosphor layer 22, a light-reflecting layer 23, a second rigid sheet 25, and a frame (i.e., spacer frame) 26. In this case, the phosphor layer 22 is placed on the second rigid sheet 25 via the light-reflecting layer 23.

At least one of the rigid sheets is preferably rigid to a level enough to keep the radiation image storage panel from deforming in the radiation image reading procedure. Accordingly, the rigid sheet preferably has a modulus of elasticity of not less than 9.8×10³ MPa, more preferably in the range of 1.96×10⁴ to 9.8×10⁶ MPa.

The rigid sheet preferably has a low air permeation as well as a low water permeation. It is preferred that the rigid sheet has a reduced water permeation (25° C.) of not more than 300 g/m²·24 hrs·μm. Moreover, it is preferred that the rigid sheet absorbs radiation as little as possible. Accordingly, the rigid sheet preferably is a glass sheet (sheet of inorganic glass or organic glass), a sheet of plastic material, a sheet of CFRP (carbon fiber-reinforced resin), a sheet of GFRP (glass fiber-reinforced resin), or a metal sheet such as aluminum sheet, magnesium sheet or beryllium sheet, or a ceramic sheet.

Preferred is a glass sheet, such as a silicate glass sheet. Commercially available glass sheets such as FL0.7, FL0.85, and FL1.0 available from Central Glass Co., Ltd.; UFF0.40, UFF0.50, UFF0.55, and UFF0.70 available from Nihon Flat Glass Cc., Ltd.; and RRQS40SX available from Asahi Glass Works Co., Ltd., are preferably employed.

The first rigid sheet can be produced of material equal to that of the second rigid sheet. At least one of the rigid sheets, that is a rigid sheet through which the radiation image is read out, should be transparent. The total thickness of the two rigid sheets preferably is in the range of 100 to 10,000 μm, more preferably in the range of 1000 to 5,000 μm. The thickness of the first rigid sheet can be the same as or different from that of the second rigid sheet.

On one of the rigid sheets is placed a phosphor layer, if desired, via an auxiliary layer.

The phosphor preferably is a stimulable phosphor which emits a stimulated emission having a wavelength of 300 to 500 nm when it is irradiated with a stimulating light having a wavelength of 400 to 900 nm.

The stimulable phosphor preferably is an alkali metal halide phosphor having the formula (I):

M^{I}X·aM^{II}X′₂·bM^{III}X″₃:zA (I)

in which M^{I} is at least one alkali metal element selected from the group consisting of Li, Na, K, Rb and Cs; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Tb, Dy, Ho, Er, Tm, Yb, Lu, Na, Mg, Cu, Ag, Tl and Bi; and a, b and z are numbers satisfying the conditions of 0≦a<0.5, 0≦y<0.5 and 0<z≦1.0, respectively.

In the formula (I), Cs is preferably included as M^{I}, Br is preferably included as X, and A is particularly preferably Eu or Bi. The phosphor of the formula (I) may contain a metal oxide (such as aluminum oxide, silicon dioxide or zirconium oxide) as an additives in an amount of not more than 0.5 mol based on 1 mol of M^{I}.

Another preferred stimulable phosphor is a rare earth activated alkaline earth metal fluoride-halide phosphor having the following formula (II):

M^{II}FX:zLn (II)

in which M^{II} is at least one alkaline earth metal element selected from the group consisting of Ba, Sr and Ca; Ln is at least one rare earth element selected from the group consisting of Ce, Pr, Sm, Eu, Fb, Dy, Ho, Nd, Er, Tm and Yb; X is at least one halogen selected from the group consisting of Cl, Br and I; and z is a number satisfying the condition of 0<z≦0.2.

In the formula (II), Ba is preferably included in an amount of half or more of M^{II}, and Ln particularly preferably is Eu or Ce. The M^{II}FX in the formula (II) indicates the crystal structure of BaFX, and it by no means indicates F:X=1:1. The formula (II), therefore, does not indicate resultant stoichiometric composition. It is generally preferred to produce many F⁺(X⁻) centers (which are vacant lattice points of X⁻ ion) in a BaFX crystal, so as to enhance the efficiency of emission stimulated by light in the wavelength region of 600 to 700 nm. In many cases, F is in slight excess of X.

One or more of the following additives may be added into the phosphor of the formula (II), if needed, although they are omitted in the formula (II):

bA, wN^{I}, xN^{II}, yN^{III}

In the above formula, A is a metal oxide such as Al₂O₃, SiO₃ or ZrO₂. For preventing M^{II}FX particles from sintering, A is preferably inactive to M^{II}FX and is preferably in the form of fine particles (the mean size of primary particles is not more than 0.1 μm). N^{I} is a compound of at least one alkali metal element selected from the group consisting of Li, Na, K, Rb and Cs; N^{II} is a compound of alkaline earth metal element Mg and/or Be; and N^{III} is a compound of at least one trivalent metal element selected from the group consisting of Al, Ga, In, Tl, Sc, Y, La, Gd and Lu.

The letters b, w, x and y represent added amounts of the additives, based on 1 mol of M^{II}FX when the additives are added into the phosphor. They satisfy the conditions of 0≦b≦0.5, 0≦w≦2, 0≦x≦0.3 and 0≦y≦0.3. The amounts of the additives often decrease during sintering and washing processes, and hence the b, w, x and y do not always indicate the ratios of the components in the resultant phosphor. Some of the additives are not changed to remain in the resultant phosphor, but others are reacted with or incorporated in M^{II}FX.

Further, other additives can be added to the phosphor of the formula (II), if needed. Examples of the additives include Zn and Cd compounds; metal oxides such as TiO₂, BeO, MgO, CaO, SrO, BaO, ZnO, Y₂O₃, La₂O₃, In₂O₃, GeO, SnO₂, Nb₂O₅, Ta₂O₅ and ThO₂; Zr and Sc compounds; B compounds; As and Si compounds; tetrafluoroborates; hexafluoro compounds (monovalent or divalent salts of hexafluorosilicate, hexafluorotitanate and hexafluorozirconate); and compounds of transition metal such as V, Cr, Mn, Fe, Co and Ni. Furthermore, whether the above additives are incorporated or not, any rare earth activated alkaline earth metal fluorohalide stimulable phosphor can be used in the invention.

The phosphor used in the invention is not restricted to a stimulable phosphor. A phosphor giving a spontaneous emission in the ultraviolet or visible wavelength region when it absorbs a radiation such as X-ray can be also employed in the invention. Examples of these phosphors include LnTaO₄:(Nb,Gd), Ln₂SiO₅:Ce, LnOX:Tm (where Ln is a rare earth element), CsX (where X is a halogen), Gd₂O₂S:Tb, Gd₂O₂S:Pr,Ce, ZnWO₄, LuAlO₃:Ce, Gd₃Ga₅O₁₂:Cr,Ce and HfO₂.

The formation of the phosphor layer on the rigid sheet is described below. The phosphor layer is preferably formed on the rigid sheet (substrate) by vapor deposition in which the evaporation source for the phosphor material is vaporized and deposited on the rigid sheet.

The vaporization of evaporation source and deposition of the produced vapor can be performed in a commercially available vacuum evaporation apparatus comprising a vacuum chamber equipped with a vacuum pump, a supporting plate for evaporation source, heating means, and a supporting means for a substrate on which the vapor is to be deposited.

For performing the vacuum evaporation, the evaporation source is placed directly on the supporting plate or placed in a crucible or dish which is then placed on the supporting plate. A number of evaporation sources can be employed in the vacuum evaporation. The substrate is attached to the supporting means in the position over the evaporation sources.

On the substrate, a phosphor film is deposited. The phosphor film is preferably formed by electron beam deposition which employs electron beam to heat the evaporation source. The electron beam evaporation generally gives regularly aligned prismatic crystals having good shape.

It is preferred that the evaporation procedure (that is, a combination of production and deposition of vapor) are performed in the vacuum chamber at a partial pressure of water of 7.0×10⁻³ Pa or lower.

In the vacuum evaporation apparatus, an electron beam generated by an electron gun is applied onto the evaporation source. The accelerating voltage of electron beam preferably is in the range of 1.5 kV to 5.0 kV. By applying the electron beam, the evaporation source of matrix component is heated, vaporized, and deposited on the substrate. The deposition rate of the matrix component generally is in the range of 0.1 to 1,000 μm/min., preferably in the range of 1 to 100 μm/min. The substrate may be cooled or heated, if needed, during the deposition process.

By the above-described vapor deposition procedure, a phosphor film (or layer) is produced on the substrate. The phosphor film preferably has a thickness of 50 to 1,000 μm, more preferably 200 to 700 μm.

The phosphor film in which the prismatic stimulable phosphor crystals are aligned almost perpendicularly to the substrate is formed. Thus formed phosphor film comprises only the stimulable phosphor with no binder, and there are produced cracks extending the depth direction in the phosphor film.

The vacuum evaporation or deposition method is not restricted to the electron beam-evaporating method, and various known methods such as resistance-heating method, sputtering method, and CUD method can be used.

The produced phosphor film can be separated from the substrate and then placed on a different substrate.

If desired, on or under the phosphor layer is placed a light-reflecting layer or a light-absorbing layer.

A frame is then fixed on the substrate (rigid sheet) having the phosphor film thereon using an adhesive under the condition that the frame surrounds the phosphor film. The adhesive preferably is an adhesive showing low air permeation and low water permeation. Examples of the preferred adhesives are adhesives of organic resin such as epoxy resin, phenolic resin, cyanoacrylate resin, vinyl acetate resin, vinyl chloride resins polyurethane resin, acrylic resin, ethylene-vinyl acetate resin, polyolefin resin, chloroprene resin, or nitrile resin; or a silicone adhesive.

Onto the frame is fixed a second rigid sheet using such an adhesive as that described above.

Before the second rigid sheet is fixed onto the frame, a filling material can be placed within the frame on the phosphor layer. The filling material preferably has a light weight, a low density and a low radiation absorption. Examples of the filling materials include non-woven cloth, synthetic fibers, natural fibers, glass fibers, and fabrics of these fibers; porous materials such as urethane foam, polyethylene terephthalate foam, porous ceramics, micro-filters; resins, particularly resins having a density of not higher than 1.7 g/cm³, such as polyethylene terephthalate, polycarbonate, polyurethane, acrylic resin, epoxy resin, and a mixture of balloon particles (e.g., balloon polymer particles) and a resinous binder. The resinous binder can be one of thermoplastic elastomers such as polystyrene elastomer, polyolefin elastomer, polyurethane elastomer, polyester elastomer, polyamide elastomer, polybutadine elastomer, ethylene-vinyl acetate elastomer, polyvinyl chloride elastomer, natural rubber, fluorinated rubber, polyisoprene, chlorinated polyethylene, styrene-butadiene rubber and silicone rubber.

In the case that the filling material is adhesive material, the filling material can be utilized as the adhesive.

The present invention is further described by the following examples.

### EXAMPLE 1

(1) Formation of Phosphor Film

Two rigid sheets (aluminosilicate glass sheet, 430 mm×450 mm, thickness: 700 μm) were prepared.

One rigid sheet (first rigid sheet) was mounted to a substrate holder within an evaporation apparatus. In the apparatus, an evaporation source (CsBr and EuBr) was placed in a platinum boat and arranged in the predetermined sites. Subsequently, the apparatus was evacuated to reach 2.0×10⁻⁴ Pa.

In the apparatus, an electron beam from an electron gun (accelerating voltage: 4.0 kV) was applied onto the evaporation source so as to deposit a CsBr:Eu layer on the rigid sheet in the central area at a rate of 30 μm/min.

After the evaporation-deposition was complete, the inner pressure was returned to atmospheric pressure, and the rigid sheet was taken out of the apparatus. On the rigid sheet, a film (thickness: approx. 500 μm) consisting of prismatic phosphor crystals (width: approx. 20 μm, length: approx. 500 μm) aligned densely and perpendicularly was formed.

(2) Fixation of Frame

A soda lime flat glass prepared by a floating method was processed by abrasive water-jet procedure to give a spacer frame (a: 430 mm, b: 450 mm, width (c): 7 mm, average thickness (d): 2 mm, radius (R) of arc of the corner: 1 mm, variation of thickness: ±0.2 mm).

On the periphery (non-phosphor film area) of the first rigid sheet was coated a polyurethane adhesive using a dispenser in dry atmosphere. Subsequently, the frame was fixed onto the adhesive area under pressure, and placed in an oven heated to 80° C. for curing the adhesive.

(3) Preparation of Light-Reflecting Layer

A dispersion was prepared by dispersing alumina particles (average diameter; 0.6 μm) and a high molecular weight acrylic resin in a weight ratio of 15:1 in an organic solvent. The dispersion was coated on a support having a releasing layer to give a film of 100 μm thick and dried to give a light-reflecting film. The light-reflecting film was peeled off the support and fixed on the phosphor layer using an adhesive.

(4) Fixation of Second Rigid Sheet

On the frame (fixed on the first rigid sheet) was coated a polyurethane adhesive in dry atmosphere. The second rigid sheet was placed and pressed on the adhesive coated frame. Thus formed composite structure was kept at 25° C. for 24 hours, and subsequently at 50° C. for 3 days.

Thus, a radiation image storage panel of the invention having a structure of FIG. 6 was prepared. In FIG. 6, the radiation image storage panel is composed of a first rigid sheet 31, a phosphor film 32, a light-reflecting layer 33, a second rigid sheet 35, and a spacer frame 36.

### EXAMPLES 2 TO 6

The procedures of Example 1 were repeated except for employing glass frames having the dimensions set forth in Table 1, to prepare radiation image storage panels.

### COMPARISON EXAMPLE 1

The procedures of Example 1 were repeated except for employing a glass frame having the dimensions set forth in Table 1, to prepare a radiation image storage panel for comparison.

### Evaluation of Radiation Image Storage Panel

The radiation image storage panels were subjected to evaluation of sealing characteristic in the following manner.

X-rays were radiated onto a radiation image storage panel, and a stored radiation was read out by linearly scanning a stimulating light and detected the stimulated emission using a line sensor. The detected emission was marked as the initial value.

The radiation image storage panel was then stored in a thermostat set to 55° C., 95%RH, for 30 days. Subsequently, the stored storage panel was subjected to the same evaluation. Then, the reduction of stimulated emission was calculated according to the following formula:

Reduction of stimulated emission (%)=(1−(initial value−value after storage)/initial value)×100

The results are set forth in Table 1.

TABLE 1

| | Frame | | | Reduction (%) |
|---|---|---|---|---|
| | Thickness | | Variation of | of stimulated |
| | (mm) | Corners | thickness (mm) | emission |
| Ex. 1 | 2.0 | Arc (R= 1 mm) | ± 0.2 | 15 |
| Ex. 2 | 1.1 | Arc (R=0.5 mm) | ± 0.2 | 17 |
| Ex. 3 | 1.7 | Polygonal | ± 0.15 | 10 |
| | | (135°, two edges,length | | |
| | | of straight line: 10 mm) | | |
| Ex. 4 | 1.7 | Arc (R= 2 mm) | ± 0.1 | 9 |
| Ex. 5 | 1.7 | Arc (R= 1 mm) | ± 0.1 | 10 |
| Ex. 6 | 2.0 | Arc (R= 2 mm) | ± 0.7 | 23 |
| Com.1 | 1.7 | Right angle | ± 0.2 | 30 |

As is apparent from the results set forth in Table 1, the radiation image storage panels satisfying the condition of the invention show excellent sealing performance to satisfactorily keep the initial sensitivity.

What is claimed is:

1. A radiation image storage panel having an air-tightly closed space formed of two rigid sheets and a frame placed between the sheets and a phosphor layer placed in the closed space, wherein the frame has four corners in the form of concave arc or concave polygon of obtuse angles.

2. The radiation image storage panel of claim 1, wherein all corners are in the form of concave arc having a radius in the range of 0.5 to 200 mm.

3. The radiation image storage panel of claim 1, wherein all corners are formed of concave polygons each of whose corners has an angle of more than 135°.

4. The radiation image storage panel of claim 1, wherein the frame has thicknesses varying within 30% based on an average of the thicknesses.

5. The radiation image storage panel of claim 1, wherein the frame is made of glass material.

6. The radiation image storage panel of claim 1, wherein the phosphor layer is placed in contact with one of the rigid sheets.

7. The radiation image storage panel of claim 6, wherein the phosphor layer is a layer of stimulable phosphor which is deposited on the rigid sheet by electron beam deposition.

8. The radiation image storage panel of claim 7, wherein the stimulable phosphor is an alkali metal halide phosphor having the formula (I):
M^{I}X·aM^{II}X′₂·bM^{III}X″₃:zA (I)
in which M^{I} is at least one alkali metal element selected from the group consisting of Li, Na, K, Rb and Cs; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; A is at least one rare earth element or metal element selected from the group consisting of Y, Ce, Pr, Nd, Sm, Eu, Gd, Th, Dy, Ho, Er, Tm, Yb, Lu, Na, Mg, Cu, Ag, Tl and Bi; and a, b and z are numbers satisfying the conditions of 0≦a<0.5, 0≦y<0.5 and 0<z≦1.0, respectively.
